(19) United States
(12) Patent Application Publication
(10) Pub. No.: US 2005/0081054 A1
(43) Pub. Date: Apr. 14, 2005

(54) Wireless communication terminal having screen information protection function and method thereof

(76) Inventor: Jung-Ho Choo, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/961,437

(22) Filed: Oct. 7, 2004

(30) Foreign Application Priority Data
Oct. 9, 2003 (KR) 2003-70260

(51) Int. Cl. H04K 1/00

(52) U.S. Cl. 713/200; 713/182; 380/54

(57) ABSTRACT

Provided are a wireless communication terminal having a screen information protection function, a method thereof, and a computer-readable recording medium for recording a program that implements the method. The wireless communication terminal can perform protection on screen information based on a predetermined protection unit so as to make the screen information illegible to other people and thus protect the user's privacy, when the user performs a particular operation with the wireless communication terminal. The wireless communication terminal having a screen information protection function includes an input means for receiving a screen information protection mode request signal and a screen information protection mode release signal; a control means for performing functions related to screen information protection based on a signal inputted through the input unit; and an output means for outputting information obtained by performing the screen information protection function on a screen.

### FIELD OF THE INVENTION

The present invention relates to a wireless communication terminal having a function of screen information protection, a method thereof and a computer-readable recording medium for recording a program that implements the method; and, more particularly, to a wireless communication terminal that can perform protection on screen information so as to make the screen information illegible to other people and protect the user's privacy, when the user performs a particular operation with the wireless communication terminal based on a predetermined protection unit, such as drawing up a short message or a multimedia message including a photo, picture, music and the like, a method thereof and a computer-readable recording medium for recording a program that implements the method.

### DESCRIPTION OF RELATED ART

Wireless communication terminals mentioned in the present invention include mobile communication terminals, personal communication service (PCS), personal digital assistants (PDA), smart phones, International Mobile Telecommunication 2000 (IMT-2000), wireless Local Area Network (LAN) terminals and the like, and they are terminals that are capable of wireless communication and carried by an individual. Hereinafter, the present invention will be described by taking a mobile communication terminal as an example.

Also, screen information mentioned in the present invention means information displayed on a screen of the wireless communication terminal, such as a short message which is being typed in by a user, a multimedia message which includes a photo, video, music along with a short message, a multimedia content which is being played, an address/telephone book which is being searched, and the like. Hereinafter, the present invention will be described by taking an example of writing a short message or an e-mail message in the mobile communication terminal.

A short message service (SMS) mentioned in the present invention is a service in which users can send/receive a message as short as about 80 letters without any additional device. As the mobile communication terminals come into wide use rapidly, the use of the SMS service, too, increases in proportion to the use of mobile communication terminals. Since the short message is received by a receiving part as soon as it is transmitted, which is different from an e-mail, it is used more widely.

In addition, the SMS has an advantage that it can be used anytime anywhere because users always carries their mobile communication terminal with them. However, when a user types a short message into the mobile communication terminal in a public place, such as a subway, car, bus and the like, to use the SMS, the user can feel uncomfortable in fear that other people around him may peep out the message while he writes it, especially when the message is very personal.

Therefore, a method for protecting the screen information from the eyes of other people is required when the user types the short message or the e-mail message in a wireless communication terminal in a public place.

### SUMMARY OF THE INVENTION

It is, therefore, an object of the present invention to provide a wireless communication terminal having a screen information protection function, a method thereof and a computer-readable recording medium for recording a program that implements the method. The wireless communication terminal can perform protection on screen information based on a predetermined protection unit so as to make the screen information illegible to other people and thus protect the user's privacy, when the user performs a particular operation with the wireless communication terminal, such as writing a short message or a multimedia message having a photo, picture, music and the like.

In accordance with an aspect of the present invention, there is provided a wireless communication terminal having a screen information protection function, including: an input unit for receiving a screen information protection mode request signal and a screen information protection mode release signal; a control unit for performing functions related to screen information protection based on a signal inputted through the input unit; and an output unit for outputting information obtained by performing the screen information protection function on a screen.

In accordance with another aspect of the present invention, there is provided a method for protecting information screen information in a wireless communication terminal, including the steps of: a) establishing a screen information protection mode based on a screen information protection mode request signal; b) performing screen information protection based on a pre-established screen information protection unit during a particular operation; and c) releasing the screen information protection mode based on a screen information protection mode release signal.

In accordance with another aspect of the present invention, there is provided a method for protecting screen information in a wireless communication terminal, including the steps of: a) establishing a screen information protection mode based on a screen information protection mode request signal in the middle of a particular operation; b) performing screen information protection on screen information based on a pre-established screen information protection unit; and c) releasing the screen information protection mode when the particular operation is completed.

In accordance with another aspect of the present invention, there is provided a computer-readable recording medium for recording a program that implements a screen information protecting method in a wireless communication terminal having a processor, the method including the steps of: a) establishing a screen information protection mode based on a screen information protection mode request signal; b) performing screen information protection on screen information based on a pre-established screen information protection unit during the particular operation; and c) releasing the screen information protection mode based on a screen information protection mode release signal.

In accordance with another aspect of the present invention, there is provided a computer-readable recording medium for recording a program that implements a screen information protecting method in a wireless communication terminal having a processor, the method including the steps of: a) establishing a screen information protection mode based on a screen information protection mode request signal in the middle of a particular operation; b) performing screen information protection on screen information based on a pre-established screen information protection unit; and c) releasing the screen information protection mode when the particular operation is completed.

### BRIEF DESCRIPTION OF THE DRAWINGS

The above and other objects and features of the present invention will become apparent from the following description of the preferred embodiments given in conjunction with the accompanying drawings, in which:

FIG. 1 is an exemplary view showing a mobile communication terminal having a screen information protection function in accordance with an embodiment of the present invention;

FIGS. 2 to 6 are exemplary views describing a screen information protecting method for a mobile communication terminal in accordance with an embodiment of the present invention;

FIG. 7 is a flowchart describing a screen information protecting method for a mobile communication terminal in accordance with an embodiment of the present invention; and

FIG. 8 is a flowchart describing a screen information protecting method for a mobile communication terminal in accordance with another embodiment of the present invention.

### DETAILED DESCRIPTION OF THE INVENTION

Other objects and aspects of the invention will become apparent from the following description of the embodiments with reference to the accompanying drawings, which is set forth hereinafter.

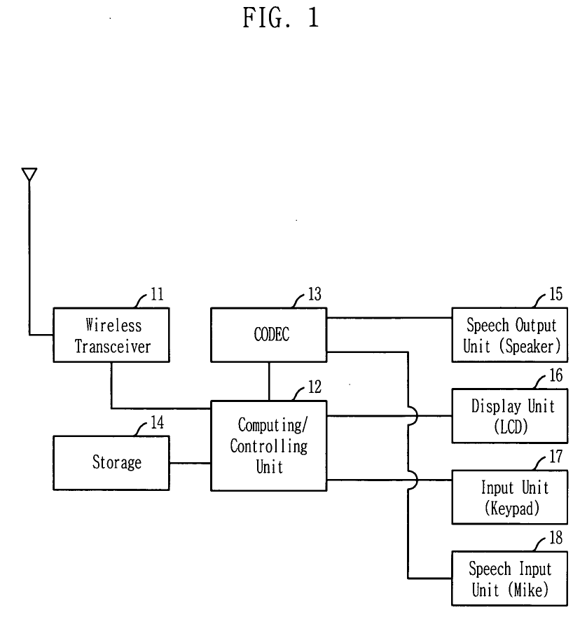

FIG. 1 is an exemplary view showing a mobile communication terminal having a screen information protection function in accordance with an embodiment of the present invention.

As shown, the mobile communication terminal having a screen information protection function includes a wireless transceiver 11, a computing/controlling unit 12, a codec 13, a storage 14, a speech output unit 15, e.g., a speaker, a display unit 16, e.g., a liquid crystal display (LCD), an input unit 17, e.g., a key pad, and a speech input unit 18, e.g., a mike.

The wireless transceiver 11 transmits and receives signals through an antenna wirelessly. The computing/controlling unit 12 operates and controls the mobile communication terminal and, if a short message or an e-mail message is typed more than a predetermined unit, it shades the typed letters based on a screen information protection mode request signal which is inputted through the input unit 17.

The codec 13 converts the signal transmitted from the wireless transceiver 11 into speech and outputs the speech through the speech output unit 15 based on the control of the computing/controlling unit 12, and converts the speech transmitted from the speech input unit 18 into signals, transmits the signals to the computing/controlling unit 12 and outputs the signals through the wireless transceiver 11. The storage 14 stores a program and file systems (including images, characters and icons) for operating the mobile communication terminal.

The speech output unit 15, e.g., a speaker, outputs speech transmitted from the codec 13. The display unit 16, e.g., an LCD, outputs the message or the e-mail message shaded in the computing/controlling unit 12. The input unit 17, e.g., a key pad, receives a phone number, menu selection information, a screen information protection mode request signal and a screen information protection mode release signal, and a short message typing signal through buttons. The speech input unit 18, e.g., a mike, transmits the speech to the codec 13.

In the present invention, if a short message or an e-mail message is typed more than a predetermined unit of letters, shading is given to the typed letters. The screen information protection mode for shading the type letters can be set up in advance by the user in a menu or it can set up by the user pressing a specific key or button in the middle of drawing up the message.

Here, if the screen information protection mode is set up by the menu establishment, it is applied to every short message or e-mail message to be typed henceforth until a screen information protection mode release signal is inputted. Otherwise, if the screen information protection mode is set up by inputting a button or a key in the middle of the typing of the short message or the e-mail message, it is released automatically after the transmission of the message is completed.

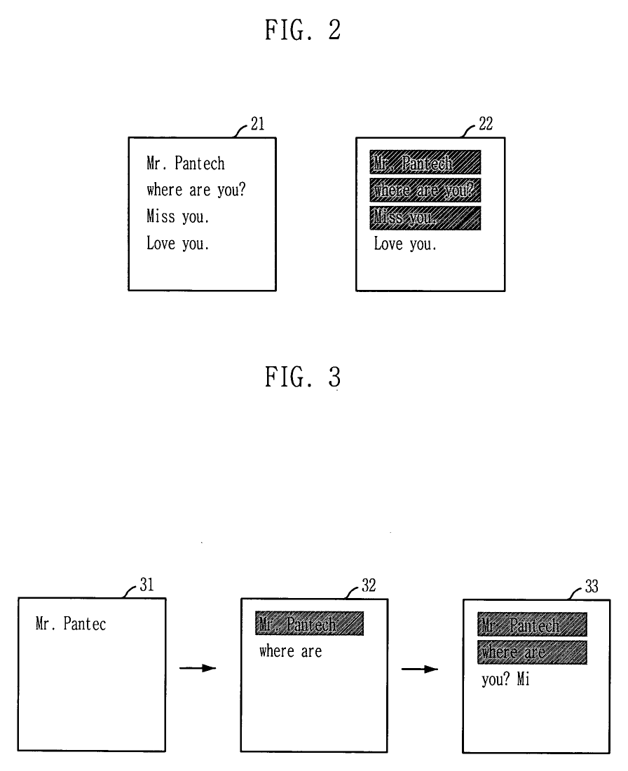

The overall process will be described more in detail with reference to FIGS. 2 and 6.

FIGS. 2 to 6 are exemplary views describing a screen information protecting method for a mobile communication terminal in accordance with an embodiment of the present invention.

Conventionally, a short message which is being typed is displayed without any protection, just as shown in “21” of FIG. 2. If a user means to type such personal expressions in a public place, he will feel uncomfortable because he is conscious of the eyes of other people around him.

To address the problem, the technology of the present invention shades the short message and displays as shown in “22” of FIG. 2. In other words, if letters are typed more than a predetermined protection unit of letters, the typed letters are displayed with shades on them based on the protection unit. This way, the short message can be protected from the eyes of other people. Here, the protection unit can be a syllable, a word or a word clause, a line and the like. Also, the protection unit can be established during the manufacturing of the mobile communication terminal or by a user's arbitrary selection from the menu. Hereinafter, various protection units will be described.

First, if the protection unit is established on a line basis, the shading is given as shown in FIG. 3. That is, if a short message or an e-mail is typed (see “31”) and an input cursor moves to another line, which means the line is changed, the previous line of letters is shaded as shown in “32” and “33” of FIG. 3.

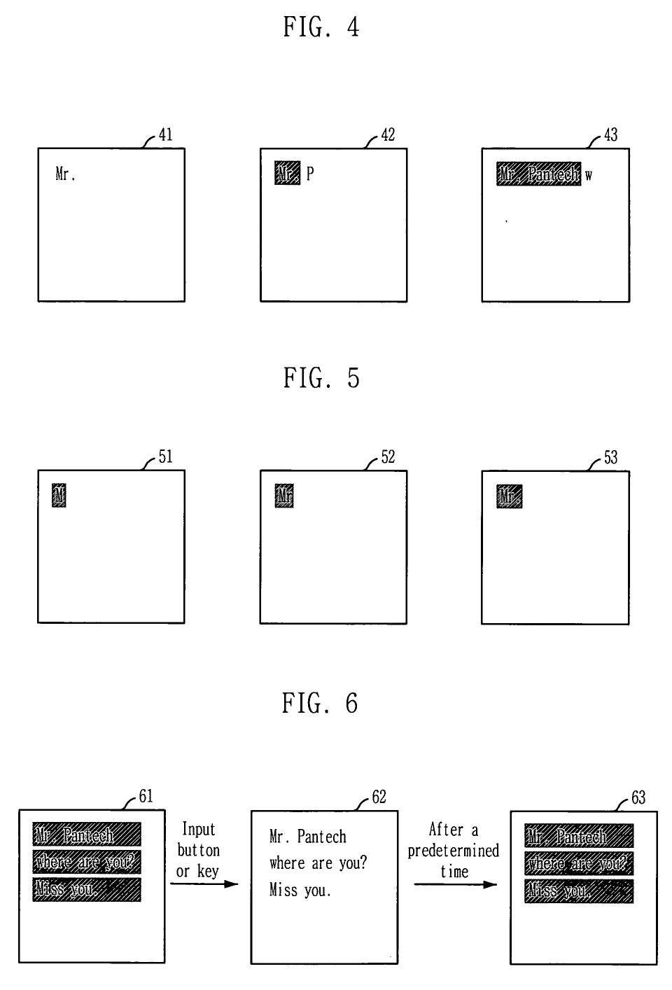

If the protection unit is established on a word basis, the shading is given as shown in FIG. 4. That is, if a short message or an e-mail is typed (see “41”) and a space letter (“ ”) is inputted and the letters prior to the input of the space letter are shaded as shown in “42” and “43” of FIG. 4.

If the protection unit is established on a letter basis, the shading is given as shown in FIG. 5. That is, when a short message or an e-mail is typed (see “51”), shading is given to each letter as shown in “52” and “53” of FIG. 5.

Meanwhile, as illustrated in FIG. 6, if the screen information protection mode is set up and letters typed by a user are all shaded but the user inputs a screen information protection mode release signal by pressing a specific key or button to see the short message or e-mail message without screen information protection, the screen information protection mode is released temporarily and the shading is removed to show the entire message (see “62”). Here, if a predetermined time, e.g., five seconds, passes, the screen information protection mode is resumed as shown in “63” of FIG. 6. The resumption of the screen information protection mode can be carried out by pressing a key or a button.

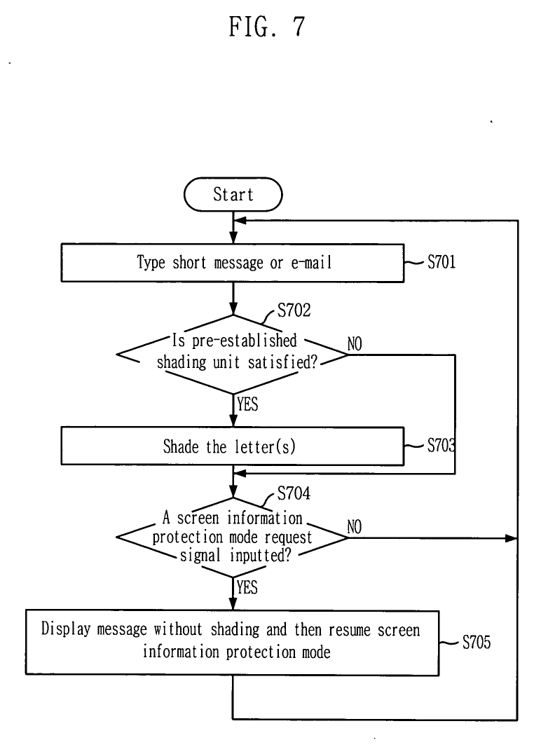

FIG. 7 is a flowchart describing a screen information protecting method for a mobile communication terminal in accordance with an embodiment of the present invention.

First, at step S701, a screen information protection mode is set up based on a screen information protection mode request signal which is transmitted through an input unit 17 to a computing/controlling unit 12 and a short message or an e-mail message is typed. At step S702, it is checked whether the inputted letters (or the location of an input cursor) satisfies a pre-established protection unit. If the pre-established protection unit is satisfied, the letters are shaded. If the pre-established protection unit is not satisfied, the logic flow goes to a step S704 directly.

At step S704, it is checked whether a screen information protection mode release signal is inputted in the computing/controlling unit 12. If the screen information protection mode release signal is not inputted, the logic flow goes to the step S701. If the screen information protection mode release signal is inputted, at step S705, the short message or the e-mail message is displayed without shading (i.e., the screen information protection mode is released) and, after a predetermined time passes, the message resumes the shading and the logic flow goes to the step S701 (i.e., the screen information protection mode is established).

The process of the steps S701 through S705 is repeated until the short message or the e-mail message is completed, or until a transmission key is pressed. Also, even in the middle of the process from S701 to S705, the user can release the screen information protection mode or re-establish the protection unit by pressing a menu key for establishing the screen information protection mode.

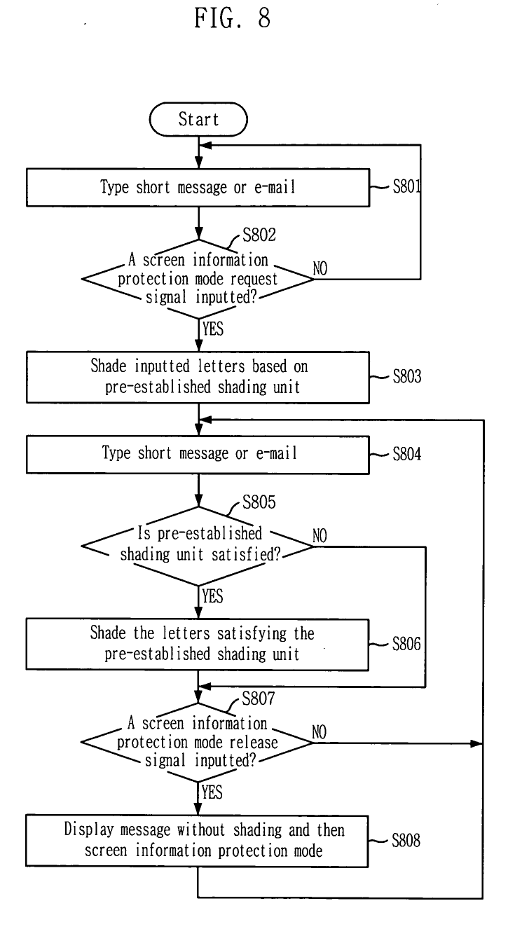

FIG. 8 is a flowchart describing a screen information protecting method for a mobile communication terminal in accordance with another embodiment of the present invention.

First, at step S801, the computing/controlling unit 12 of the mobile communication terminal performs a function of drawing up a short message or an e-mail message. At step S802, a screen information protection mode request signal is received through the input unit 17 during the message is drawn up. At step S803, shading is given to the inputted message based on a pre-established protection unit.

At step S804, the short message or e-mail is drawn up and, at step S805, it is checked whether an inputted letter or the location of the input cursor satisfies the pre-established protection unit. If it satisfies the protection unit, at step S806, the letters are shaded. If it does not satisfy the protection unit, the logic flow goes to a step S807.

At the step S807, the computing/controlling unit 12 checks whether a screen information protection mode release signal is inputted. If the screen information protection mode release signal is not inputted, the logic flow goes to the step S804. If the screen information protection mode release signal is inputted, at step S808, the short message or the e-mail message is displayed without shading, which means the screen information protection mode is released, and then after a predetermined time passes the screen information protection mode is resumed, which means the screen information protection mode is re-established, and the logic flow goes to the step S804.

Subsequently, the screen information protection mode is released when the transmission of the short message or the e-mail message is completed. Even in the middle of the process from S801 through S808, the user can re-establish the protection unit or release the screen information protection mode by pressing a menu key such as a key for setting up the screen information protection mode.

In accordance with another embodiment of the present invention, it is possible to make the computing/controlling unit 12 shade letters by pressing a specific button or a key and inputting a screen information protection mode request signal through the input unit in the middle of typing a short message or an e-mail message. In this case, there is no need to go through an additional process to establish the screen information protection mode.

In accordance with yet another embodiment of the present invention, screen information can also be protected by making the color of typed letters the same as or similar to that of the background. Here, the color change unit can be established on a basis of a syllable, word or word clause, line and the like.

In accordance with still another embodiment of the present invention, screen information can be protected from the eyes of other people within a predetermined distance by lowering the clarity of the typed letters or darkening the brightness of the background, or backlight. In this case, too, the brightness changing unit can be established on a basis of a syllable, word or word clause, line and the like.

All the embodiments of the present invention can be easily applied not only to short messages but also to multimedia messages (which are short messages including a photo, video and music) which is being typed, multimedia contents which is being played, and screen information showing personal information such as an address book and the like. The protection unit can be established differently according to the characteristics of screen information to be protected.

The technology of the present invention can protect user's privacy by performing a protection process based on a pre-established screen information protection unit to thereby make the screen information illegible to other people, when the user performs a particular operation with a wireless communication terminal, such as typing a short message and a multimedia message including a photo or a picture.

While the present invention has been described with respect to certain preferred embodiments, it will be apparent to those skilled in the art that various changes and modifications may be made without departing from the scope of the invention as defined in the following claims.

1. A wireless communication terminal having a screen information protection function, comprising:
an input means for receiving a screen information protection mode request signal and a screen information protection mode release signal;
a control means for performing functions related to screen information protection based on one of the screen information protection mode request signal and the screen information protection mode release signal; and
an output means for outputting information obtained by performing the screen information protection function on a screen.

2. The wireless communication terminal as recited in claim 1, wherein the control means performs protection on screen information based on the screen information protection mode request signal which is inputted through the input means during a particular operation.

3. The wireless communication terminal as recited in claim 1, wherein the control means establishes/releases the screen information protection mode based on the signal inputted through the input means and, if the screen information protection mode is established, the control means performs protection on screen information based on a pre-established screen information protection unit.

4. The wireless communication terminal as recited in claim 3, wherein the control means establishes the screen information protection mode upon receipt of the screen information protection mode request signal, performs screen information protection based on the pre-established screen information protection unit during a particular operation, and releases the screen information protection mode upon receipt of the screen information protection mode release signal.

5. The wireless communication terminal as recited in claim 1, wherein the control means receives the screen information protection mode request signal in the middle of a particular operation and establishes the screen information protection mode, performs screen information protection based on the pre-established screen information protection unit, and releases the screen information protection mode when the particular operation is completed.

6. The wireless communication terminal as recited in claim 1, wherein the control means receives the screen information protection mode release signal inputted through the input means in the state of the screen information protection mode, displays the screen information without the screen information protection by releasing the screen information protection mode, and then resumes the screen information protection mode after a predetermined time passes.

7. The wireless communication terminal as recited in claim 1, wherein the control means shades the screen information to protect the screen information.

8. The wireless communication terminal as recited in claim 1, wherein the control means makes the color of the screen information the same as or similar to the color of a background of the screen to protect the screen information.

9. The wireless communication terminal as recited in claim 1, wherein the control means lowers brightness of the screen information to protect the screen information.

10. The wireless communication terminal as recited in claim 1, wherein the control means darkens brightness of the background in overall to protect the screen information.

11. The wireless communication terminal as recited in claim 1, wherein the protected screen information includes a short message which is being typed, a multimedia message which is being drawn up, a multimedia content which is being played, and a personal address/telephone book which is being searched, the multimedia message being a short message having a photo, video or music.

12. A method for protecting screen information in a wireless communication terminal, comprising the steps of:
a) establishing a screen information protection mode based on a screen information protection mode request signal;
b) performing screen information protection based on a pre-established screen information protection unit during a particular operation; and
c) releasing the screen information protection mode based on a screen information protection mode release signal.

13. A method for protecting screen information in a wireless communication terminal, comprising the steps of:
a) establishing a screen information protection mode based on a screen information protection mode request signal in the middle of a particular operation;
b) performing screen information protection on screen information based on a pre-established screen information protection unit; and
c) releasing the screen information protection mode when the particular operation is completed.

14. A computer-readable recording medium for recording a program that implements a screen information protecting method in a wireless communication terminal having a processor, the method comprising the steps of:
a) establishing a screen information protection mode based on a screen information protection mode request signal;
b) performing screen information protection on screen information based on a pre-established screen information protection unit during the particular operation; and
c) releasing the screen information protection mode based on a screen information protection mode release signal.

15. A computer-readable recording medium for recording a program that implements a screen information protecting method in a wireless communication terminal having a processor, the method comprising the steps of:
a) establishing a screen information protection mode based on a screen information protection mode request signal in the middle of a particular operation;
b) performing screen information protection on screen information based on a pre-established screen information protection unit; and
c) releasing the screen information protection mode when the particular operation is completed.
